(19) United States
(12) Patent Application Publication
(10) Pub. No.: US 2018/0018537 A1
(43) Pub. Date: Jan. 18, 2018

(54) NON-SPECTROSCOPIC IMAGING OF PLANTS

(71) Applicant: Purdue Research Foundation, West Lafayette, IN (US)

(72) Inventors: Young L. Kim, West Lafayette, IN (US); Taehoon Kim, West Lafayette, IN (US)

(73) Assignee: Purdue Research Foundation, West Lafayette, IN (US)

(21) Appl. No.: 15/644,431

(22) Filed: Jul. 7, 2017

Related U.S. Application Data
(60) Provisional application No. 62/359,617, filed on Jul. 7, 2016.

(51) Int. Cl. G06K 9/46; G01J 3/28; G06K 9/20; G06K 9/00; H04N 9/04

(52) U.S. Cl. CPC G06K 9/4652; G06K 9/2027; G06K 9/00657; G01J 3/2803; G01J 2003/282; G06K 2209/17; H04N 9/045

(57) ABSTRACT

Monitoring stress symptoms in plants is crucial to maximize crop productivity. Nondestructive imaging of physiological changes in plants has been intensively used as invaluable tools in the agricultural industry. However, this approach requires a bulky and expensive optical instrument for capturing full spectral information and often has intrinsic limitations for quantitative analyses. Disclosed herein are a method and system for spectrometerless hyperspectral imaging that can map out detailed spatial distribution of chlorophyll content, which is a key trait for physiological condition of plants. The combination of a handheld-type imaging system and a hyperspectral reconstruction algorithm offers the simplicity for instrumentation and operation avoiding the use of an imaging spectrograph. This imaging platform can be integrated into a compact, inexpensive, and portable imager for plant biologists and ecophysiologists.

### CROSS-REFERENCE TO RELATED APPLICATIONS

The present patent application is related to and claims the priority benefit of U.S. Provisional Patent Application Ser. No. 62/359,617, filed Jul. 7, 2016, the contents of which is hereby incorporated by reference in its entirety into the present disclosure.

### TECHNICAL FIELD

The present disclosure generally relates to plant imaging, and in particular to a system and method for nondestructive imaging of physiological changes in plants.

### BACKGROUND

This section introduces aspects that may help facilitate a better understanding of the disclosure. Accordingly, these statements are to be read in this light and are not to be understood as admissions about what is or is not prior art.

Abiotic and biotic stress (e.g. drought, nutrient deficiency, temperature, and pathogen attack) impacts plant growth and development, eventually influencing crop yield. For example, it is estimated that the extreme drought in 2014 resulted in a revenue loss of $1.5 billion in the California's agricultural economy. Thus, it is critical to assess stress symptoms during early alteration stages before irreversible damage and yield loss occur, allowing for strategic intervention (e.g. rewatering). Loss of chlorophyll is one of the key symptoms that plants display under such stress. In addition, as transgenic breeding becomes widely available, the agricultural industry needs quantitative plant phenotyping technologies for specific selection of pathogen resistant, stress tolerant, and high yielding plants. Overall, there is a strong need for plant imaging technologies that nondestructively and quantitatively visualize stress traits in situ.

There are a few methods currently available for quantifying chlorophyll content. Since subtle alterations in chlorophyll are not visible until they reach a certain level, destructive biochemical analyses serve as the gold standard. Optical meters, which quantify chlorophyll content as spot-measurements, are also used as an advanced method, given the nondestructive nature of the technologies. However, these methods provide the level of chlorophyll content in a spot area lacking the information on spatial distribution. In this respect, fluorescent imaging of chlorophyll has received considerable attention as a nondestructive imaging method. Indeed, chlorophyll fluorescence imaging serves as a valuable tool for quantifying leaf photosynthetic efficiency. On the other hand, quantitative assessment using chlorophyll fluorescent signals is intrinsically limited, depending on measurement parameters including excitation illumination and emission detection. Thus, fluorescence signals in plants serve as a proxy measure or an indirect indicator of photosynthesis. There is thus an unmet need for a method and system to accurately and sensitively quantify chlorophyll content, while resolving the spatial heterogeneity.

### BRIEF DESCRIPTION OF THE FIGURES

FIG. 1 is a schematic showing the concept of spectrometerless, yet hyperspectral imaging that can be recapitulated as ‘virtual’ hyperspectral imaging for plants using a conventional RGB camera.

FIG. 2 is a plot showing the correlation between the spectral index SI for chlorophyll content and the biochemical assays. The solid line is a linear regress fit and the dotted lines are 95% confidence intervals. The inset is a representative reflectance spectrum from Arabidopsis thaliana at a high chlorophyll concentration.

FIGS. 3A-3D are photographs of nondestructive, quantitative, and label-free chlorophyll imaging on mesoscopic scales (i.e. between microscopic and canopy scales). FIGS. 3A and 3C are photographs of Arabidopsis thaliana samples. FIGS. 3B and 3D are corresponding chlorophyll images.

FIG. 4 is a hyperspectral reconstruction of full spectral information from RGB. Representative comparison between original spectral data obtained using the laboratory hyperspectral system with the full spectral information and reconstructed data from RGB information. Inset: Spectral response of the three-color CCD camera.

FIG. 5A is a schematic diagram of an embodiment of a spectrometerless hyperspectral imaging system.

FIG. 5B is a photograph of a working prototype of a spectrometerless hyperspectral imaging system according to one embodiment.

FIGS. 6A and 6B are chlorophyll images generated by the laboratory hyperspectral system and the system of FIG. 5B with the three-color CCD camera using the hyperspectral reconstruction, respectively.

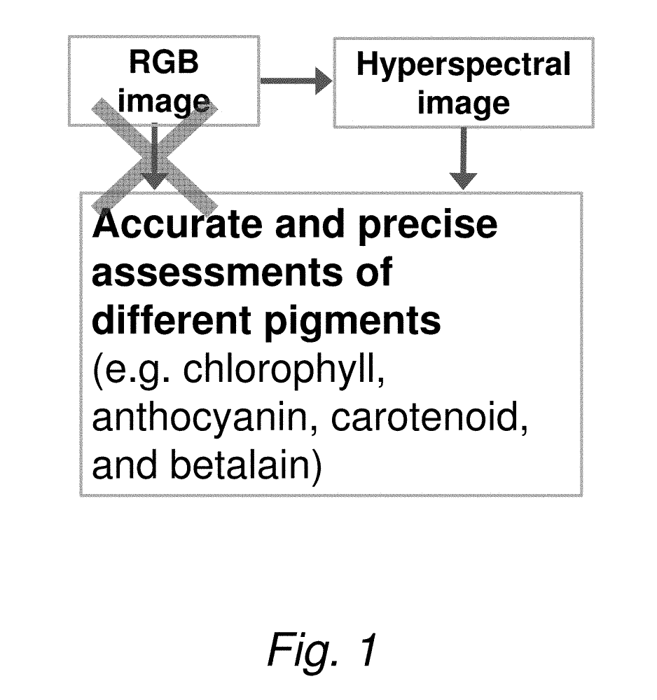

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

For label-free imaging, conventional hyperspectral imaging systems rely on the use of a mechanical filter wheel, an imaging spectrograph, or a liquid crystal tunable filter, all of which limit the development of simple, compact, and cost-effective systems. To build compact and affordable systems for widespread utilization, it is also critical to implement a spectrometerless imaging system. Such a system can be realized by utilizing an algorithm that can reliably reconstruct full spectral information from RGB image data, which are easily acquired by commonly used three-color CCD (or CMOS) cameras. Several methods for spectral reconstruction with RGB data have been studied extensively. The most common methods can be categorized into three groups: Wiener estimation, PCA-based linear models, and multivariate polynomial regression. Thus, these hyperspectral reconstruction methods using RGB data could potentially lead to the simplicity for instrumentation and operation without using bulky and expensive spectrometers.

Disclosed herein is a spectrometerless reflectance imaging method that allows for nondestructive and quantitative chlorophyll imaging in individual leaves in situ in a handheld device format. Reflectance spectral patterns can correlate with chlorophyll content in leaves assessed by biochemical analyses. In one embodiment, a laboratory system coupled with an imaging spectrograph with a high spectral resolution is utilized to obtaining a detailed reflectance spectrum in each (x, y) location. In one laboratory example, Arabidopsis thaliana was used. In another embodiment, the total chlorophyll content was measured in each sample using biochemical assays. Numerical experiments for extracting chlorophyll content without using hyperspectral image data were also conducted. A hyperspectral reconstruction algorithm was implemented that reliably reconstructs the full spectral information in plant leaves from RGB data. In one embodiment, a handheld-type spectrometerless imaging system comprising a three-color CCD camera and a white-light LED as a detector and a light source, respectively, is provided and used to test the sample. Finally, detailed chlorophyll imaging is demonstrated at a mesoscopic imaging level (i.e. between microscopic and canopy scales) in a pilot testing example.

The herein described mesoscopic hyperspectral imaging system for obtaining experimental spectra from leaf samples, allows acquisition of a matrix of backscattered intensity as a function of x, y, and the wavelength λ of light. The specification includes a transverse resolution of ˜100 μm with a field of view of 15² mm², an imaging depth of ˜1 mm, and a spectral range of 400-770 nm with a spectral solution of 2 nm. In particular, a back-directional (angular) filtering scheme in the detection part collects the light reflected from the sample within a narrow solid angle of θ=±2° in the exact backward direction. Back-directional angular filtering enhances a spatial resolution and an image contrast by removing a significant amount of unwanted scattered or diffusive light. More importantly, this configuration avoids spectral variations originating from different systems, because reflectance spectra are highly sensitive to illumination and detection geometries. This aspect is crucial to apply the hyperspectral reconstruction algorithm trained by the laboratory system to the spectrometerless imaging system later.

In one example, a series of leaf samples from Arabidopsis thaliana, a well-known model plant, was obtained for covering a wide range of chlorophyll content. Arabidopsis thaliana ecotype Col-0 was cultivated at a light intensity of 100 μE m⁻² sec⁻¹ at 22° C. under a photoperiod of 16-hour light/8-hour dark. Rosette leaves were detached from four-week old plants, were incubated in a solution of 3 mM MES (2-[N-morpholino] ethanesulfonic acid) at pH 5.7, and were kept under dark for up to six days. For conventional biochemical assays, chlorophyll with 95% ethyl alcohol was extracted after incubating the samples at 70° C. for one hour. Then, absorbance at 665 nm and 649 nm was measured using a UV/visible spectrophotometer. Finally, total chlorophyll content (i.e. chlorophyll a and chlorophyll b) was calculated in the unit of μg/mg (i.e. chlorophyll/fresh weight) as previously described.

To map out detailed spatial distribution of leaf chlorophyll concentration in the actual unit of μg/mg, a chlorophyll spectral index, and a conversion curve from the spectral index to the value of chlorophyll concentration, and a hyperspectral imaging data set was combined as follows: First, for plant chlorophyll content quantification, the extensively used spectral index for chlorophyll content was exploited, according to Equation (1):

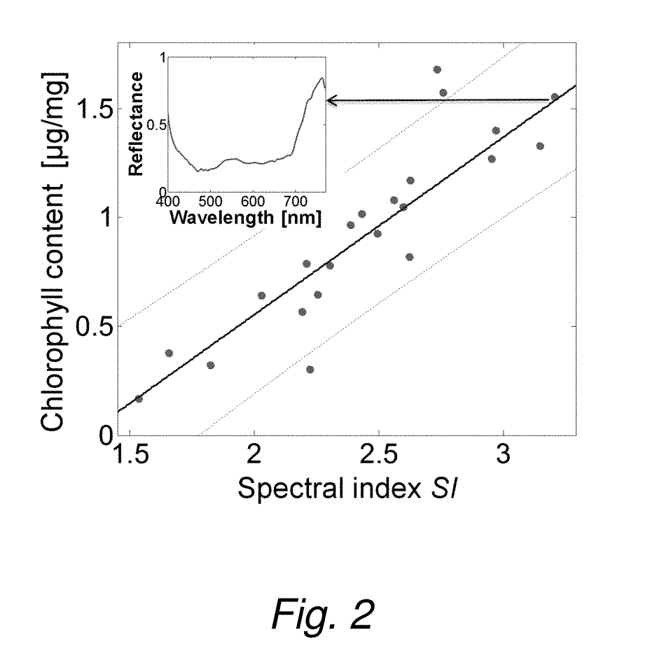

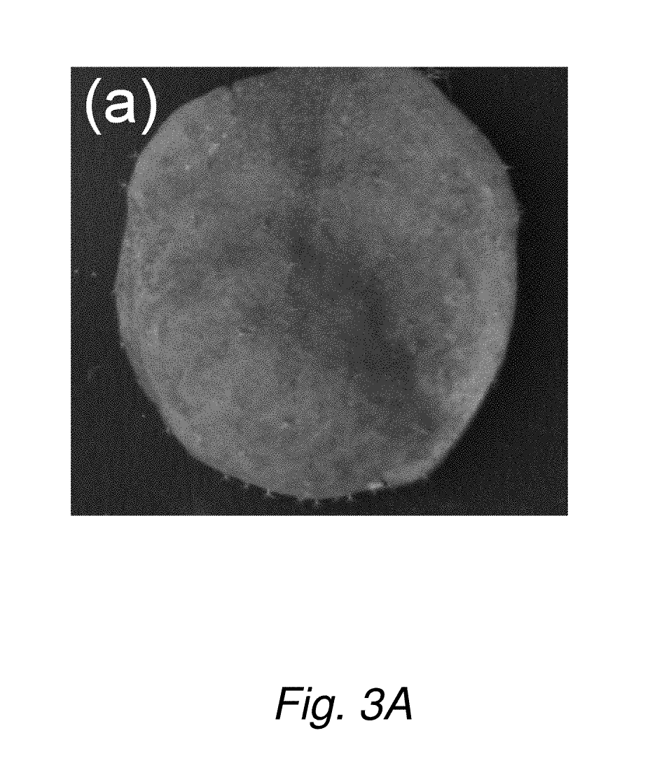

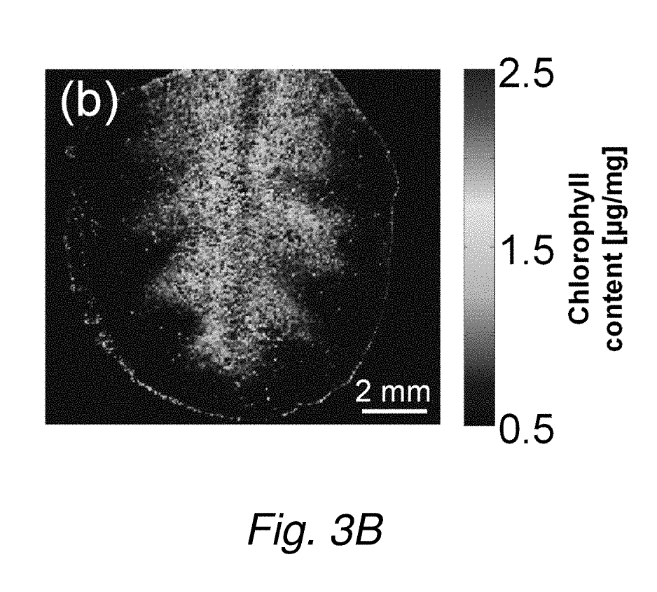

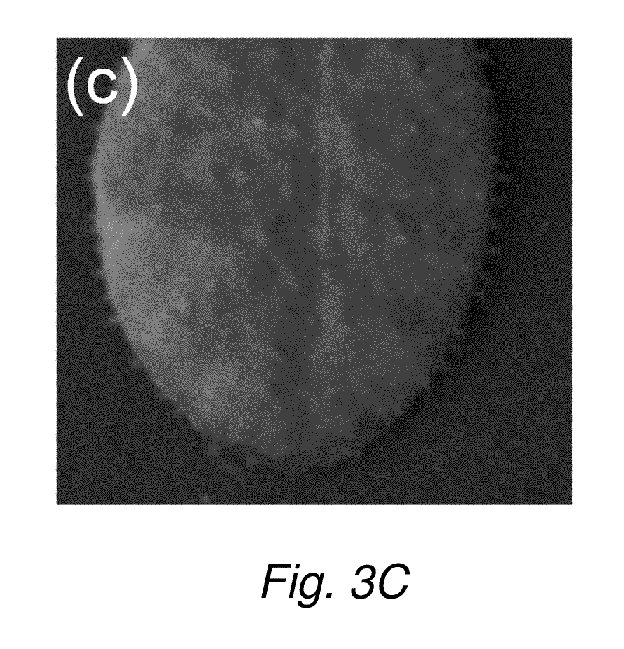

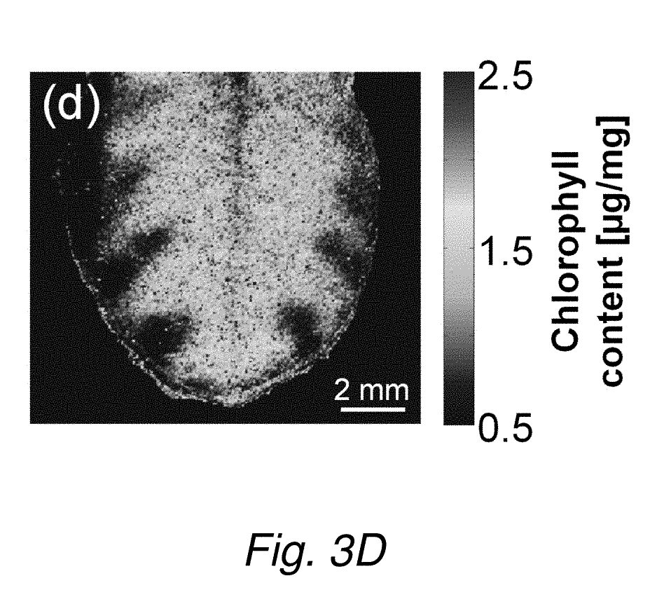

SI=[R(750)−R(445)]/[R(705)−R(445)] (1)

where R(λ) is the reflectance intensity. This approach has not yet been used for detailed visualization of chlorophyll content in individual leaves, in part because of the lack of appropriate hyperspectral systems, although this has been used in canopy and remote sensing measurements. Second, the correlation between SI and chlorophyll content was validated, when the reflectance spectra from the entire leaves were averaged and the total chlorophyll content were measured with the biochemical assays. FIG. 2 shows that the p-value of the slope estimate of linear regression between SI and chlorophyll content is <0.001 and the correlation coefficient is 0.89, supporting the statistically significant linear association. In turn, this relationship served as a conversion curve from SI to chlorophyll content to extract the value of chlorophyll concentration. Third, this spectral calculation in each (x, y) pixel was extended to generate a planar image of chlorophyll content in each leaf sample. As shown in FIGS. 3A-2D, the chlorophyll images reveal unique spatial distributions of chlorophyll content, which are not obvious from the conventional photographs.

Optical imaging of plants heavily rely on spectrometers, spectrographs, and tunable color filters, all of which significantly limit the development of simple, economical, and lightweight devices. To overcome this limitation, we can mathematically reconstruct spectral information from RGB using a prior hyperspectral data set of interest and the RGB spectral response of the conventional camera. Mathematical reconstruction and prediction of hyperspectral (with a high spectral resolution) imaging are possible using RGB data acquired from conventional RGB cameras. The reconstruction of full spectra from RGB data can be performed using pseudo-inverse, regression, Wiener estimation, and demultiplexing.

A hyperspectral reconstruction algorithm is numerically implemented that can reliably predict detailed spectral information from RGB data. Among several different reconstruction methods, polynomial regression is chosen for reconstructing reflectance spectra for optimal performance as follows: First, a reconstruction model is built using a group of training data set (i.e. training stage). To build a model for reconstructing reflectance spectra from RGB data, a RGB camera response v is expressed such that (Equation (2)):

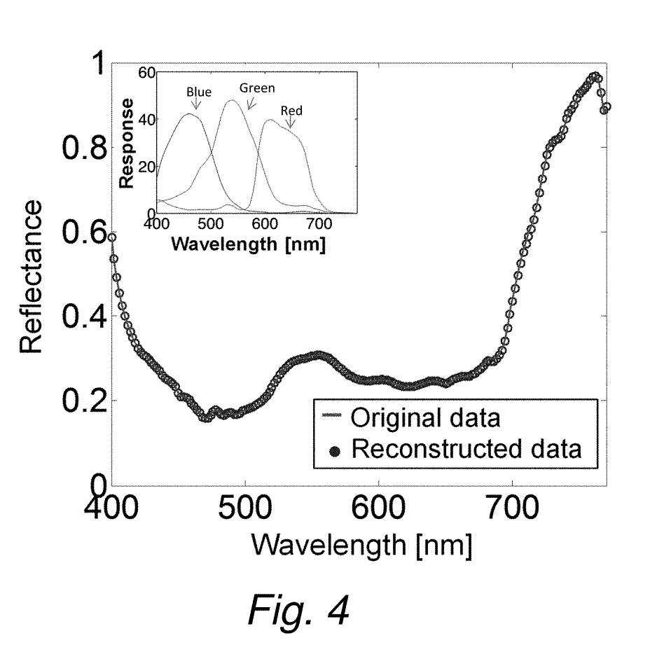

v=M×r (2)

where r is the reflectance spectrum and M is the spectral response of the system. In one example, M is obtained from the manufacturer of the three-color CCD (Sony ICX625) that was used in the handheld system (inset in FIG. 4). Because M is the reference signal measured by a reflectance standard, M corresponds to all of the system responses, including the light source, the fiber optic light guide, the telecentric lens, and the spectral sensitivity of the three-color CCD. Second, r is expressed to estimate r given M and v in terms of a conversion matrix T such that (Equation (3)):

r=v×T (3)

Third, T is determined by applying multivariate polynomial regression. Finally, r is computed. In this step, to determine the best polynomial degree, v was varied such that v=[1, v₁, v₂, v₃, v₁², v₂², v₃²] for 2^{nd}-order polynomial regression, which provided highly reliable performance in our plant hyperspectral image data.

In another example, the accuracy of the reconstructed spectral information was evaluated, using goodness-of-fit metrics (i.e. coefficient of determination R² and root mean square error (RMSE)). A predictive ability of the reconstruction model was tested utilizing a leave-one-out cross validation method (i.e. testing stage). Given our relatively small sample size (n=24), leave-one-out cross validation was a reasonable validation method for minimizing over-fitting. The representative spectra in FIG. 3 show that the full reflectance spectra data can be reliably reconstructed from the RGB data, compared to the original hyperspectral data. After including all of the samples with multivariate polynomial regression (degree=2), a RMSE of cross validation was 0.013 and an adjusted R² was 0.99. Overall, this numerical evaluation supports the feasibility that chlorophyll content can be sensitively and accurately estimated using a three-color sensor-based system.

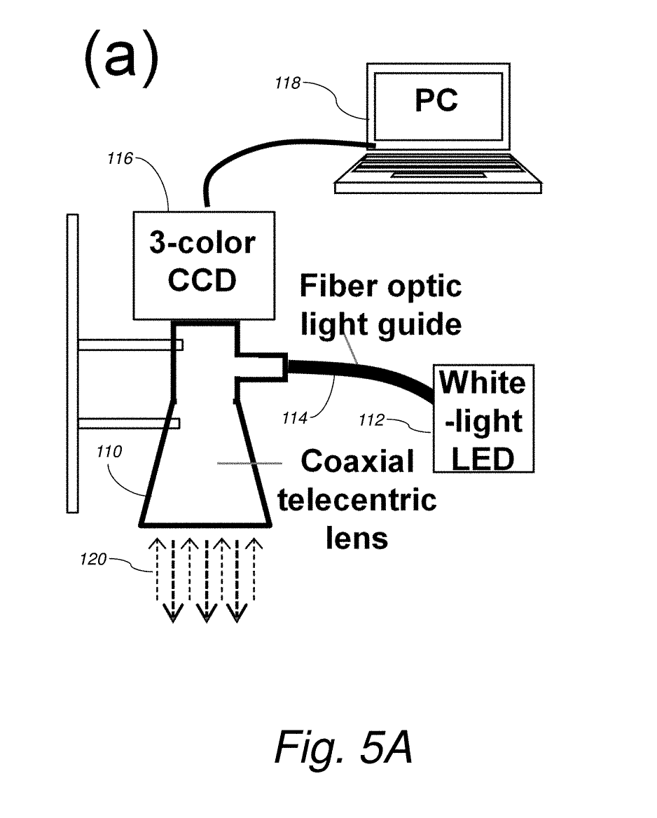

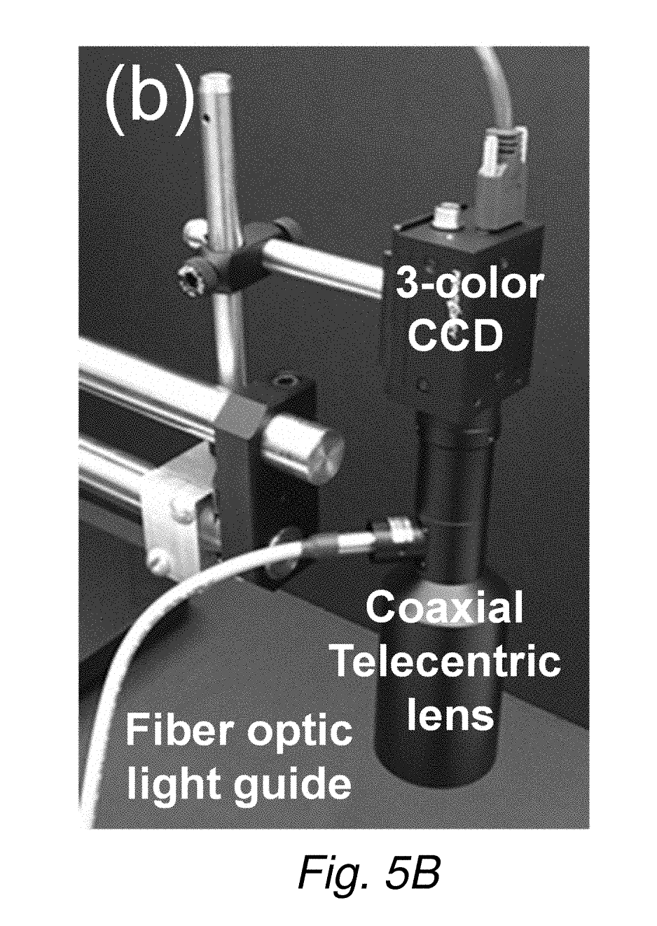

One embodiment of a spectrometerless hyperspectral imaging system 100 is shown FIG. 5A. FIG. 5B shows a photograph of the tested prototype. The system 100 comprises a 3-color charged coupled device (CCD) 116, a white-light source 112 (e.g., a LED white light source), and a computer processing unit 118 which has associated memory, data storage and output display components. To directly use the hyperspectral reconstruction algorithm that was developed using the laboratory system, it was important to minimize any spectral variations resulting from different illumination and detection configurations. Thus, the illumination and detection configurations of the laboratory system were mimicked in the prototype system. In particular, a telecentric lens 110 with coaxial illumination (also known as an inline telecentric lens) is connected to the CCD 116 to allow imaging the light (arrows 120) scattered from the sample in the exact backward direction with respect to the incident light and acted as back-directional angular gating in the reflection mode. A white-light LED 112 is coupled to the telecentric lens 110 via a fiber optic light guide 114 and is illuminated onto the sample. The light 120 reflected from the sample is collected using the same telecentric lens mounted to the 3-color CCD 116. In one example, the system 100 had a field of view of 70 mm×60 mm with a pixel size of 56 μm. Similarly to the laboratory measurements, RGB image data sets were normalized by reference signals from a reflectance standard to correct the nonuniformity of the light source and the color response of the detection system 100.

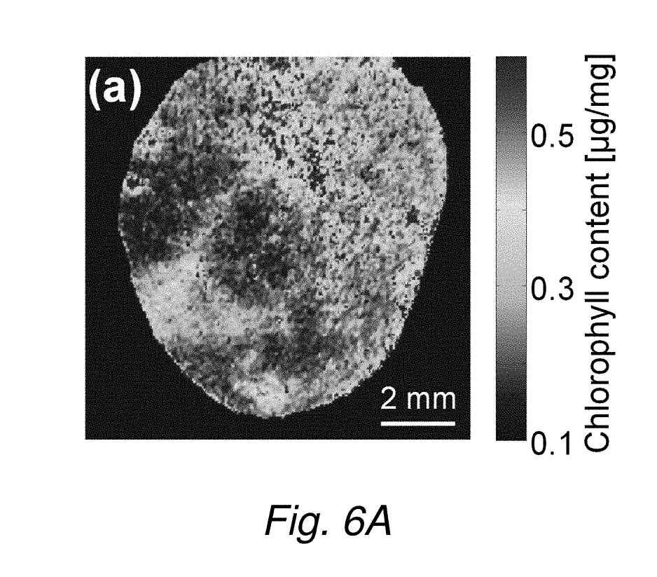

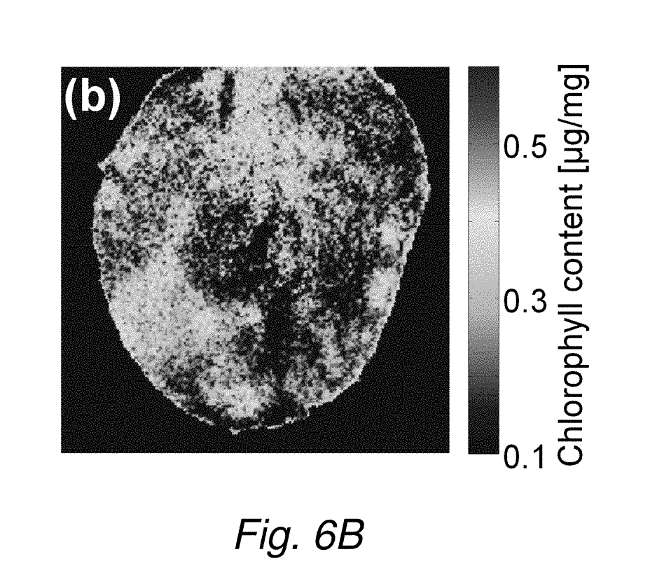

In one example, hyperspectral image data and RGB image data was acquired from new Arabidopsis samples in a sequential manner. After the samples were scanned using the original laboratory imaging system (with the imaging spectrograph), the identical samples were imaged using the handheld prototype system (with the three-color CCD). FIGS. 6A and 6B depict representative chlorophyll images from the original system and the prototype system, respectively. The spatial distribution patterns of chlorophyll content are very similar to each other with a 2-dimensional correlation coefficient of 0.93. We note that the subtle discrepancy in the two chlorophyll images was originated from rapid dehydration in detached leaves, because the data acquisition time of the original system was relatively slow (˜10 minutes). In addition, the exact validation of the hyperspectral reconstruction algorithm was challenging, because the two systems had different pixel sizes and imaging areas, and because the sample orientation to the system was not the same. Thus, an integrated imaging system would produce more reliable comparison results in generating quantitative chlorophyll images from RGB data. Overall, this pilot test demonstrates that our working prototype of the spectrometerless imaging system has the potential of detailed spatial and temporal imaging of chlorophyll content.

This proof-of-concept study demonstrates that the presently disclosed spectrometerless imaging method is capable of nondestructive and quantitative in situ imaging of chlorophyll content on mesoscopic scales. This not only confirms the correlation between the reflectance spectra pattern and the chlorophyll content, but also visualized detailed spatial distribution of chlorophyll content in a whole leaf. Thus, it is expected that spatiotemporal imaging of chlorophyll content may detect early biotic and abiotic stress symptoms of plants. Although the presently disclosed hyperspectral reconstruction is currently applicable for Arabidopsis samples due to the Arabidopsis-based model training, the method and system are application to other types of plants and crops as well as other various pigments besides chlorophyll (for example, anthocyanin, carotenoid, and betalain). Numerical reconstructions for hyperspectral image data from RGB image data can also be performed using other methods (for example, multivariate linear regression, principal component regression, partial least square regression, and support vector machine). This capability of imaging multiple stress traits would help to deepen our understanding of stress and coping mechanisms in plants. Further, we envision that this prototype can also serve a platform for easy integration into an imaging instrument of modest price, potentially leading to widespread utilization. We note that the spectrometerless imaging method disclosed herein does not require any moving parts, such as convey-belt or fast moving in-line movements that are often used in prior art hyperspectral imaging systems.

### Additional Examples

In at least one example embodiment, the herein disclosed system and methods may be used in gardening, crop care, lawn care, and landscape maintenance settings wherein the images and methods can aid in informing users of when to water their plants. The methods and systems can be integrated into currently existing irrigation systems to permit more efficient

In another example embodiment, the herein described systems and methods can also be used with a data and image capturing device, for example a smartphone or tablet wherein the images can be captured by the image capturing device in the form of still pictures or a video and the data analyzed. Such a configuration can also permit drone-type imaging and imaging from air to, for example, detect drought or areas where plant watering or nutrient distribution is needed. The devices can also be attached to the plant leafs themselves to permit direct capturing of the images.

Those skilled in the art will recognize that numerous modifications can be made to the specific implementations described above. The implementations should not be limited to the particular limitations described. Other implementations may be possible.

Those skilled in the art will recognize that high-temporal resolution (e.g. video mode data acquisition) can be made to the specific implementations described above.

1. A method for spectrometerless imaging of a sample, comprising:
obtaining RGB image data from a sample;
applying a hyperspectral reconstruction algorithm to reconstruct the reflectance spectral patterns of the sample from the RGB data;
correlating the reflectance spectral patterns with the sample's pigment content and concentration;
applying a spectral index of the sample's pigment content; and
generating planar images of the sample.

2. The method of claim 1, wherein the method is implemented on an imaging capturing device, wherein the imaging capturing device comprises a smartphone or a tablet.

3. The method of claim 1, further comprising obtaining a plurality of reflectance spectral patterns from the sample under the same geometrical configuration of the illumination and the detection.

4. The method of claim 1, further comprising developing and maintaining a library of reflectance spectral patterns and correlating the reflectance spectral patterns with the sample's pigment content.

5. The method of claim 1, further comprising training a hyperspectral reconstruction algorithm to reconstruct the reflectance spectral patterns of the sample from the RGB data.

6. The method of claim 1, wherein the pigment contents are any one of or a combination of chlorophyll, anthocyanin, carotenoid, and betalain.

7. The method of claim 1, wherein the sample is a plant.

8. The method of claim 1, wherein the sample is a vegetable.

9. The method of claim 1, wherein the sample is a fruit.

10. The method of claim 1, wherein the imaging is nondestructive to the sample.

11. The method of claim 1, wherein the imaging can be accomplished without any (or at least any significant) contact with the sample.

12. A spectrometerless imaging system, comprising:
a detector;
a light source;
an image capturing device; and
a computer processor module, wherein the processor module is configured to:
apply a hyperspectral reconstruction algorithm to reconstruct the reflectance spectral patterns of the sample from the RGB data;
correlate the reflectance spectral patterns with the sample's pigment content and concentration;
apply a spectral index of the sample's pigment content; and
generate planar images of the sample.

13. The spectrometerless imaging system of claim 12, wherein the light source comprises a light emitting diode (LED).

14. The spectrometerless imaging system of claim 13, wherein the LED is a white-light LED.

15. The spectrometerless imaging system of claim 12, wherein the detector is any white-light source (e.g. xenon and tungsten lamps).

16. The spectrometerless imaging system of claim 12, wherein the image capturing device is a three-color CCD camera.

17. The spectrometerless imaging system of claim 12, wherein the image capturing device is a three-color CMOS camera.

18. The spectrometerless imaging system of claim 12, wherein further comprising a beam splitter, the beam splitter is coupled to the CCD camera.

19. The spectrometerless imaging system of claim 12, wherein further comprising a beam splitter, the beam splitter is coupled to the CMOS camera.

20. The spectrometerless imaging system of claim 12, further comprising a telecentric lens.

21. The spectrometerless imaging system of claim 12, further comprising an accessory to a mobile data capturing device.

22. The spectrometerless imaging system of claim 12, wherein the mobile data capturing device comprises an image capturing device.

23. The spectrometerless imaging system of claim 22, wherein the image capturing device is a smartphone or tablet.

24. The spectrometerless imaging system of claim 23, wherein the system is configured to be coupled to the smartphone or tablet.

25. The spectrometerless imaging system of claim 12, wherein the system is configured to be coupled to an unmanned aerial vehicle.
